(19) United States
(12) Patent Application Publication
(10) Pub. No.: US 2015/0039881 A1
(43) Pub. Date: Feb. 5, 2015

(54) Triggering an Internet Packet Protocol Against Malware

(71) Applicants: Edward M. Scheidt, McLean, VA (US); C. Jay Wack, Grasonville, MD (US); Ronald C. Parsons, Ijamsville, MD (US); Wai Tsang, Falls Church, VA (US)

(72) Inventors: Edward M. Scheidt, McLean, VA (US); C. Jay Wack, Grasonville, MD (US); Ronald C. Parsons, Ijamsville, MD (US); Wai Tsang, Falls Church, VA (US)

(73) Assignee: TecSec Inc., Herndon, VA (US)

(21) Appl. No.: 14/452,100

(22) Filed: Aug. 5, 2014

Related U.S. Application Data
(60) Provisional application No. 61/862,413, filed on Aug. 5, 2013.
(60) Provisional application No. 61/892,862, filed on Oct. 18, 2013.

(51) Int. Cl. H04L 29/06

(52) U.S. Cl. CPC H04L 63/1458; H04L 63/08; H04L 63/0428; H04L 63/0272
USPC 713/151; 726/23; 726/3; 726/7

(57) ABSTRACT

A process of triggering an Internet packet protocol against malware includes providing protocol trigger mechanisms configured to affect network access and data object access against malware, denial of service attacks, and distributed denial of service attacks, A multi-level security system is established with a cryptographically secure network channel, or another equivalent encrypted channel, and a second object of an encrypted document or data message that uses the secure network channel. The equivalent encrypted channel can be a Virtual Private Network tunnel (VPN) including MPPE/PPTP/CIPE/Open VPN, Secure Socket Layer (SSL), or IPSec tunnel.

### CROSS-REFERENCE TO RELATED APPLICATIONS

This is related to, and claims priority from, U.S. Provisional Application for Patent No. 61/862,413, filed on Aug. 5, 2013, and U.S. Provisional Application for Patent No. 61/892,862, filed on Oct. 18, 2013.

### FIELD OF THE INVENTION

The present invention relates to network security, data security, dynamic data encryption, and triggering actions at the network protocol level to affect network and data access. The triggering includes three actions:
1) A user or customer authentication action with a local, public Internet Service Provider (ISP),
2) A validated, secure Internet Protocol (IP) tunneling action that includes an encrypted, nested data message, and
3) A Web Port, Synchronization, Shift process that utilizes the integrity security of the previous authentication action and tunnel-nesting action.

### BACKGROUND OF THE INVENTION

It is becoming too common to hear that a financial institution, a defense institution, or a commercial institution has come under a Distributed Denial-of-Service (DDoS) attack, a Denial-of-Service (DoS) attack, or a malware attack. Such an attack is designed to deny access to users to a network or other computer or communication resource. In the case of a DDoS attack on the Internet, access is typically denied to a designated website and its network portal.
A [DDoS attack] is an attempt to make a machine or network resource unavailable to its intended users. Although the means to carry out, motives for, and targets of a DDoS attack may vary, it generally consists of the efforts of one or more people to temporarily or indefinitely interrupt or suspend services of a host connected to the Internet. (Extracted from Wikipedia, 2013)

Perpetrators of DDoS attacks typically target sites or services hosted on high-profile webservers, such as those of banks, credit card payment gateways, defense or intelligence portals, and even root name servers. The term is generally used to relate to computer networks, but is not limited to this environment.
One common method of attack involves saturating the target machine with external communications requests, such that it cannot respond to legitimate traffic, or responds so slowly as to be rendered essentially unavailable. Such attacks usually lead to a server overload. In general terms, DDoS attacks are implemented by either forcing the targeted computer(s) to reset, or consuming its resources so that it can no longer provide its intended service or obstructing the communication media between the intended users and the victim so that they can no longer communicate adequately. (Extracted from Wikipedia, 2013)

In essence, the customer's or user's facing port of the organization is part of the attack, becomes overloaded, and ceases to provide timely, or in some cases, any response. As illustrated in FIG. 1, the attacks are often set up on many, sometimes thousands of machines in advance with a specified time to go operational. Most institutions do not have a way to respond to that information, much less once the attack begins,

Various network security and content security tools have evolved over the years, but selective usage of these tools to counter DDoS attacks has had limited success. Outside of employing security tools, some organizations have been able to hide a back up to the main website as an alternative site if the main site is attacked; however, in general, organizations that deal with the public or with defense-like correspondence can be subject to a DDoS attack and hiding a portal would have limited application. Once a hidden site has been exposed, it would be considered to be compromised and potentially exposed to the future DDoS attacks. Another hidden site could be established, or the security tools are reassembled into a counter-measure that takes into account the interaction between the customer of a bank, as an example, and the bank.

Security has traditionally been approached in terms of physical location: defining perimeters, blocking access to networks and access control lists that change all the time. Network security of information has taken additional protection measures: a secure tunnel, a secure pipe, a security firewall a gateway, a password or something owned by the user. But all of these approaches are also based on the concept of finite boundaries: a circumstance that needs further defining.

The market emphasis for information security is to protect the data by an authentication method, ensure that the data is protected in transit, and ensure that the data is protected in a storage medium.

Data is collectively protected, but not individually protected. Data can be considered an object and security associated with that object may be persistent. The advent of the Cloud where data is interspersed in a storage medium adds a dimension to protecting data. Security is not only an access issue, but a distributed access issue within a mix of the Internet packet environment and a data usage environment. A broader view emerges that security can travel with the data and be stored with the data. Security can be enhanced with broader roles for encryption. However the attacker now still has many potential facets in which a denial of service can be created. The scope of defining access is shifting.

Bringing additional security to the forefront can be a challenge in that legacy and latency exist. The existing Internet and its end points consist of a mix of security devices that must be considered—a legacy picture. Within the infrastructure that network and information security exists includes an acceptable level of latency or a measure of time delay experienced in a system.

Security can become the driver for Internet and wireless implementations in which security for a digital conclave consists of data sharing, data integrity, privacy of data, and liability with data. Security needs to be viewed as a system in which the sum of the security methods or components offer a viable balance for costs, risks, and countermeasure.

One or more trigger actions can exist in an end-to-end security architecture to provide assurance that a user or customer is someone whom the receiving party knows, and someone with whom the receiving party can securely exchange communications. The user or customer may take the form of a person or that of a machine.

### BRIEF SUMMARY OF THE INVENTION

A set of three trigger actions are provided in an end-to-end security architecture to provide assurance that a user or customer is someone whom the receiving party knows, and someone with whom the receiving party can securely exchange communications. The user or customer may take the form of a person or that of a machine.

The Triggering includes three actions:
1) A user or customer authentication action with a local, public, Internet Service Provider (ISP),
2) A validated, secure encrypted Internet Protocol (IP) tunneling action that includes an encrypted object within the encrypted tunnel, and
3) A Web Port, Synchronization, Shift process that utilizes the integrity security of the pervious authentication action and tunnel-nesting action.

Trigger actions can be the result of any of the following exemplary external events:
1) An existing Internet, network packet protocol can be secured independently of an existing data protocol.
2) A data message, such as an email message, can be sent and received via an Internet packet infrastructure.
3) Synchronization between the user-customer and the end party, such as a bank is needed to ensure that the user knows the current bank web IP address for anticipated Web Port shifting.
4) The triggers are put in the IPSEC stack or another network security protocol in order to be quickly processed by the network components that currently exist.
5) The triggers are also placed within the Network Stack in the order necessary to be accessed by the appropriate network appliance.
6) In the case of the ISP facing the Internet and acting as the nearest connection to the web service/store, the quick identification of the address request can cause a first trigger.
7)The second trigger supports the synchronization of the pool of ports available for connection, which in turn lessens the burden on the ISP by spreading the address pool and off-loading any particular address that might have been utilized/targeted in the DDoS attack.
8) The third trigger is exercised by the service/store to authenticate the user and establish a cryptographically secure communication path, which in turn is supported by the cryptographic protection to the data objects within the secured connection. The encryption method is established by an object-oriented key manager, which is accessed, and an object to encrypt is selected. A label or a name for the object and an encryption algorithm are also selected, and the object is encrypted according to the encryption algorithm. The encrypted object, which can be a cryptographic keying establishment, is labeled or named. To access the object, the object label or name is read, access authorization is determined based on the object label or name, the object is decrypted, and access authorization is granted. The label or name can be, for example, a plurality of labels or names.
9) The action of the third trigger results in a multi-level security system, which may be defined as a secure network channel based on a cryptographically secure communication path, other encrypted network channels, such a Virtual Private Network tunnel (VPN), including MPPE/PPTP/CIPE/Open VPN, Secure Socket Layer (SSL), IPSec tunnel, and a second object of an encrypted document or data message which uses the secure network channel.

According to an aspect of the invention, a process of triggering an Internet packet protocol against malware includes providing protocol trigger mechanisms configured to affect network access and data object access against malware, denial of service attacks, and distributed denial of service attacks.

The process can also include providing a protocol trigger that can authenticate and validate a user and their network router to an Internet service provider.

The process can also include providing a protocol trigger that can be used to recognize and authorize a valid encrypted document or encrypted dataset that has been encapsulated at a network protocol mode.

The process can also include providing a protocol trigger that can be used to establish a bridge between a network protocol and data object protocol.

The process can also include validating an Internet public trigger by a mathematical computation of two identity numbers from a security source and the Internet protocol (IP) address.

The process can also include using a trigger to synchronize an institution's actions and a user for customer regarding a web port shift.

The process can also include using the result of the combination of trigger actions to stop a denial of service attack by more efficiently processing the request for connection. The combination of trigger actions can result in an increased assurance of an exchange of data between parties, including authentication of the included parties, allocation of connection points (port assignment) between parties, and authorization provided in order to access the requested data or information

The process can also include using multiple triggers within the IPSEC stack or another security protocol in the stack to provide more control and decision points to the network provider, thereby increasing the ability of the provider to make a more efficient and robust connection and more stable information-sharing environment.

The process can also include using one or more triggers, placed within the IPSEC stack or another security protocol in the stack to increase the assurance of identity, confidentiality, availability between the user and a service provider.

The service provider can be one or more of a store, a bank, a government agency, a military agency, or an intelligence agency

According to another aspect of the invention, a multi-level security system is established with a cryptographically secure network channel, or another equivalent encrypted channel, and a second object of an encrypted document or data message that uses the secure network channel. The equivalent encrypted channel can be a Virtual Private Network tunnel (VPN) including MPPE/PPTP/CIPE/Open VPN, Secure Socket Layer (SSL), or IPSec tunnel.

### BRIE DESCRIPTION OF THE DRAWINGS

The present invention is illustrated by way of example and not in limitation in the figures of the accompanying drawings, in which:

FIG. 1 illustrates an exemplary embodiment of a potential DDoS attacker.

FIG. 2 illustrates an exemplary embodiment of an IPSEC and TRIGGER protocol stack.

FIG. 3 illustrates an exemplary embodiment of the Internet Network components and two of three triggers.

FIG. 4 illustrates an exemplary embodiment of a Bank Customer application representing a sample application.

FIG. 5 illustrates an exemplary embodiment of a Network authentication and validation schema with an Internet Public Trigger.

FIG. 6 illustrates an exemplary embodiment of a Community Trigger.

FIG. 6A illustrates an exemplary embodiment of a Multi-Level Encryption Security system.

FIG. 7 illustrates an exemplary embodiment of a Port Shift Trigger.

FIG. 8 illustrates components in the edge-to-edge architecture that can be found for security protection in a banking environment.

### DETAILED DESCRIPTION OF THE INVENTION

The present invention includes triggering actions that provide assurance that a user or customer is someone whom the receiving party knows, and someone with whom the receiving party can securely exchange communications. The users or customer may take the form of a person or that of a machine.

Triggering consists of three actions:
1) A user or customer authentication action with a local public Internet Service Provider (ISP),
2) A validated, secure Internet Protocol (IP) tunneling action that includes an encrypted, nested data message, and
3) A Web Port, Synchronization, Shift process that utilizes the integrity security of the previous authentication action and tunnel-nesting action.

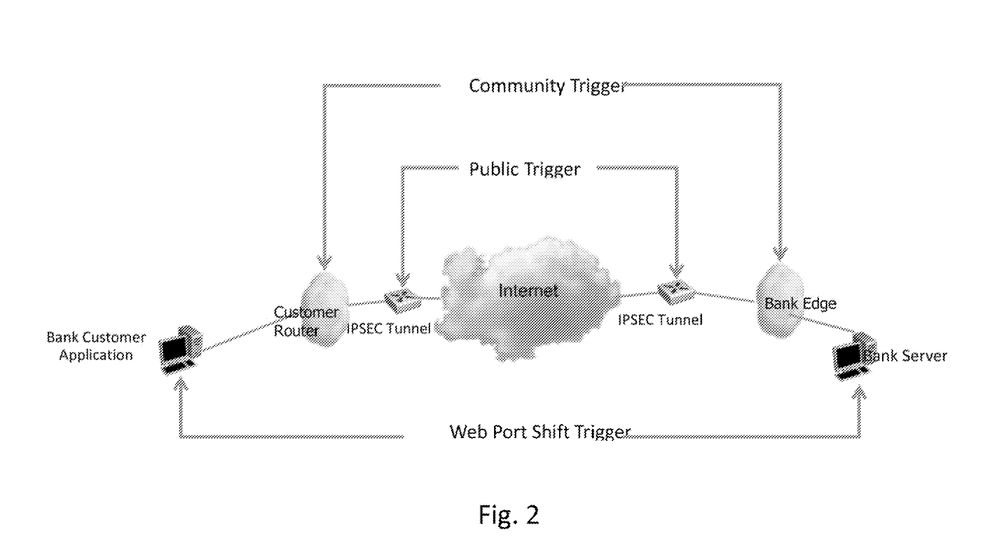

FIG. 2 illustrates an exemplary edge-to-edge banking security architecture for which triggering is included. The left edge of the illustration includes a notation for the bank customer application, which includes the functions for triggering as well as other optional banking items. As shown in FIG. 2, there is a linkage between the customer application that resides on a computing capability and a customer router that is a customer linkage to a Network communications protocol identified as Internet Public Trigger. There is a distinction between the security that is available at the Banking Community Trigger level, and the security that is available at the Internet Public Trigger level. The IPSEC Tunnel, or another security protocol for an encrypted tunnel, is associated with the Banking Community Trigger. The combined security of both levels is affected by Trigger processes and the collective result of the Triggers is used by a third Trigger to perform a countermeasure Web-Port shift Trigger process. The right edge of the illustration shows a Bank Server, which would be used for exchanging messages with the bank customer. The reference to the bank here is used as an example; the trigger actions can apply to other entities and institutions, such as those found in Commercial, Defense, and Intelligence industries.

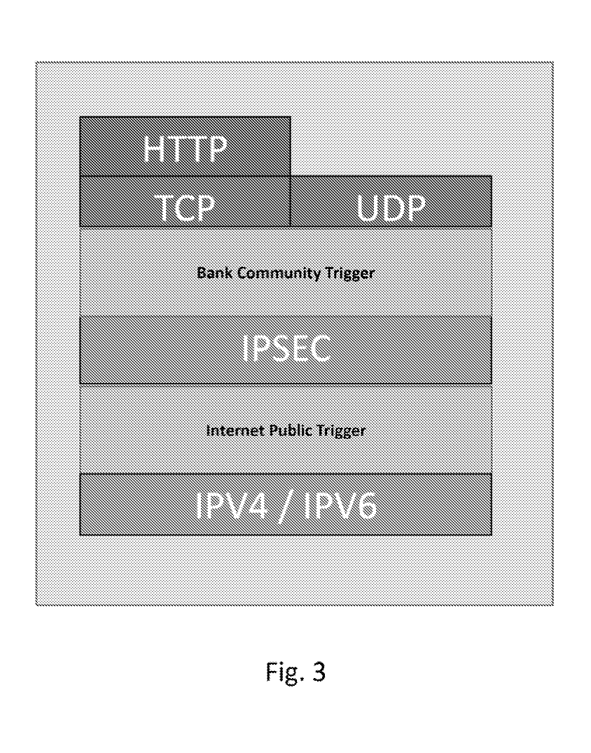

FIG. 3 is an illustration that focuses on Internet Network components and two of the three Triggers. The illustration is of an IPSEC and TRIGGER protocol stack.

The two TRIGGER actions identified in FIG. 3 are associated with a Community Trigger (the illustration includes a reference to a specific Bank Community Trigger) and an Internet Public Trigger. Both Trigger actions in this example are contained in an IPv4 network packet protocol or an IPv6 network packet protocol. From the perspective of the network packet protocol, the Internet Public Trigger can also be called an ISP Trigger, and the Community Trigger may be called Edge Router Trigger.

It is not important at this point to include specifics associated with a packet protocol but instead to note that the Triggers exist in the IP protocol stack for further actions within the Internet environment, or the Triggers may exist in another level in the security protocol stack within the Internet environment.

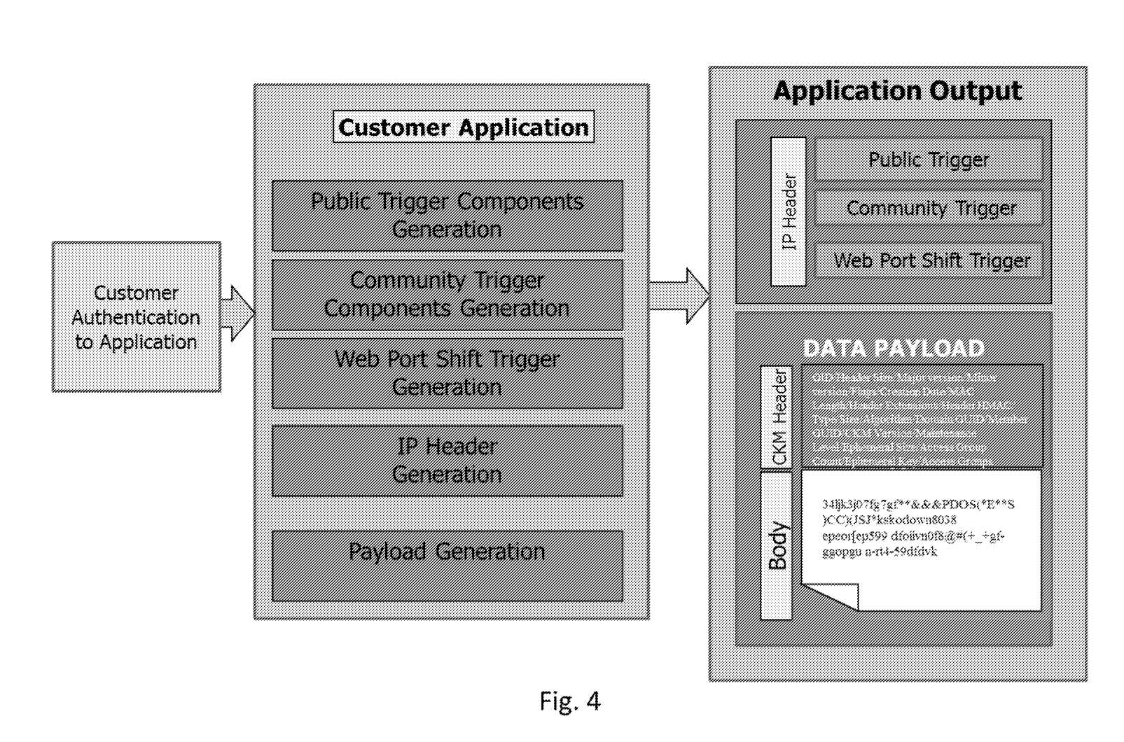

The Bank Customer Application shown in FIG. 4 is a product of the bank and is used to communicate with the bank. FIG. 4. Shows two sections of the application:
1) The customer application section includes the components to establish and use the three Triggering actions with the addition of access to the application and banking-specific items.
2) The application output section includes, as an example, the Triggering action components as part of an IP Header input and an IP Data Payload.

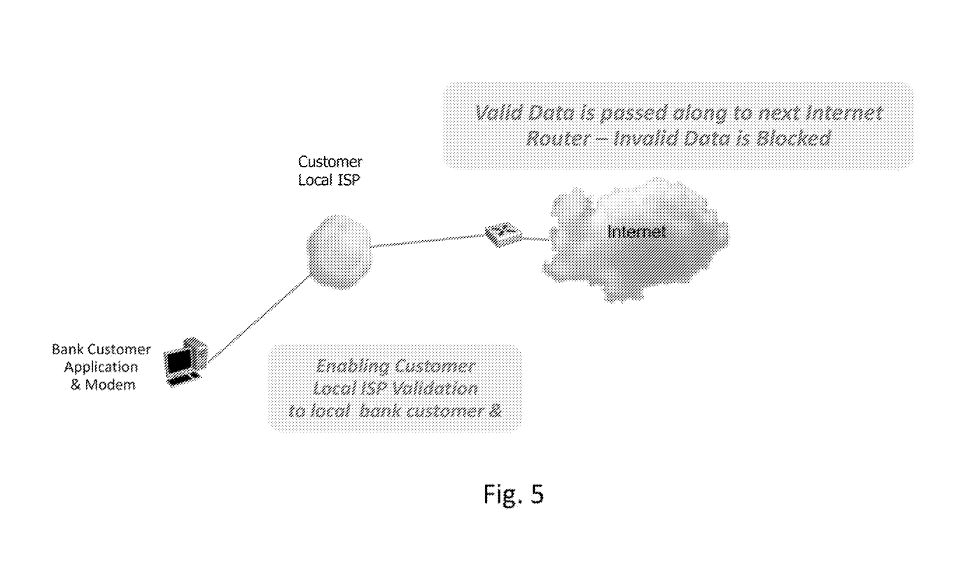

The Internet Public Trigger, as shown in FIG. 5, exists to establish an authentication and validation schema among the network user, the user's network router, and a first Internet Service Provider (ISP). The capability is done through a network user application. A security level policy is established for the user application, which will determine a security level for the Internet Public Trigger.

The Internet Public Trigger consists of two elements known to the customer application, to the application owner's edge router and to the ISP. A prearranged known answer is created for the Public Trigger by a mathematical-cryptographic combination of two numbers.
a) Number One: an exemplary identifier such as: Legal Entity Identifier (LEI—20 Character/Number) or an equivalent identifier established by an industry.
b) Number Two: a Network User router IP address which is established with the First ISP (as an example for IPv4, the IP address is 32 bits, ex: 172.16.254.1).

A mathematical computation is executed with the two numbers. The resultant computed number is used for the Triggering action. The validation is done at the ISP router, either verifying the computed number, or decrypting the number to determine the prearranged component numbers. The option is present if a latency issue surfaces at the ISP routing.

The Community Trigger exists to protect a user's or bank's data message for transmission and subsequent storage while leveraging an existing packet protocol encryption tunnel. The triggering action is done through a network routers action from the initial encryption tunnel key and subsequent encryption header of the user's or bank's encrypted document or data message.

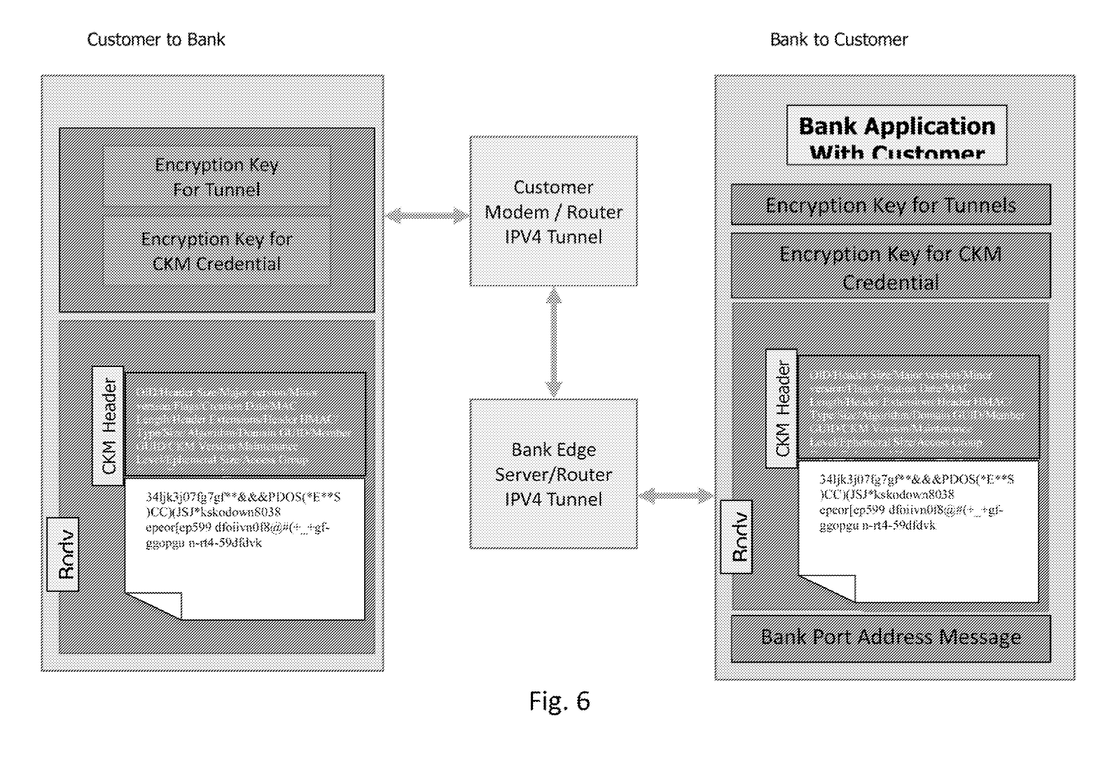

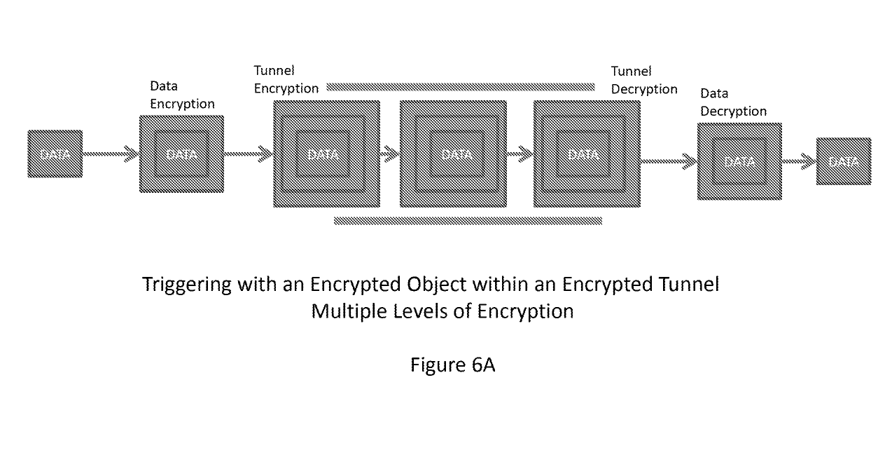

The action of validating the encryption tunnel encryption key and validating the data payload encryption header results in a triggering action also either to store the encrypted message contained in the data payload, or to decrypt the encrypted message. The FIG. 6. illustration includes the components of the action within a user application and a bank application as well as the routers for both entities. The edge router is included in a corporate and institutional back office information processing infrastructure. FIG. 6A illustrates the multiple level encryption that is the result of triggering with an encrypted object within an encrypted Tunnel.

A packet protocol encryption tunnel that is disposed between the user application and the bank edge router is transparent. An illustrated data message that would be communicated within the packet protocol encryption tunnel is disposed in the Day Payload for both entities. The document or data message example shown is of a Constructive Key Management (CKM) framework encrypted object in the form of an encrypted document or encrypted dataset.

The creation and management of the Encryption and Decryption Keys for the packet IP tunnel and the CKM encryption are known to those of skill in the art. To have a multiple-level encryption environment, a system requires a means for accessing an object-oriented key manager, means for selecting an object to encrypt, means for selecting a label or a name for the object, means for selecting an encryption algorithm, means for encrypting the object, means for labeling or naming the encrypted object, means for reading the object label or name, means for determining access authorization based on the label or name, and means for accessing the object if access authorization is granted.

The existence of a packet protocol or Secure Socket Layer (SSL) encryption tunnel that is disposed between a user application and a comparable application within a bank or other user and a second object of an encrypted document or data message within the encrypted tunnel is an example of a multi-level encryption security operation.

Security Integrity with Technologies for the Network and Information Continuity: The Internet Public Trigger strengthens identity to the network while the Bank Community Trigger includes a layered security format. Both Triggering processes rely on techniques and frameworks found in encryption. The result of this combination of techniques is that malware is countered and Denial of Services are limited.

Web Port Shift Trigger: The actions of the Public and Community Triggers establish a measured level of security integrity for a further bank or institutional action that specifically focuses on a countermeasure for a Distributed Denial of Service (DDoS).

The bank would like to maintain active correspondence with its customers, but the act of a DDoS attack minimizes or eliminates any continuity, The issue centers with the customer access to a bank's website. The DDoS attacker can know sufficient specifics of the web site to counter defenses. A technique that exists for the bank to counter such an attack has the bank move to another port. But, maintaining the customer in synch with such a bank move has not been effective.

The intent of the Port Shift trigger is to maintain continuity with the bank customer. Others who have yet to become a customer and attempt to contact the bank during a DDoS attack will not have access to the countermeasure process.

A bank-to-Internet ISP relationship can exist. Further, the bank can have a dynamic web port address assignment with the ISP that includes a set of web port addresses available for selection.

A DDoS attack is recognized, resulting in triggering actions. The bank decides to shift its current web port to an alternative web port. Actions associated with the Public and Community triggers are executed followed by an encrypted data message to their customer base that a new web port is available and citing the web port information.

The bank's action to shift the web port and synchronize that action with their customer becomes the triggering action for the Web Port Shift Trigger.

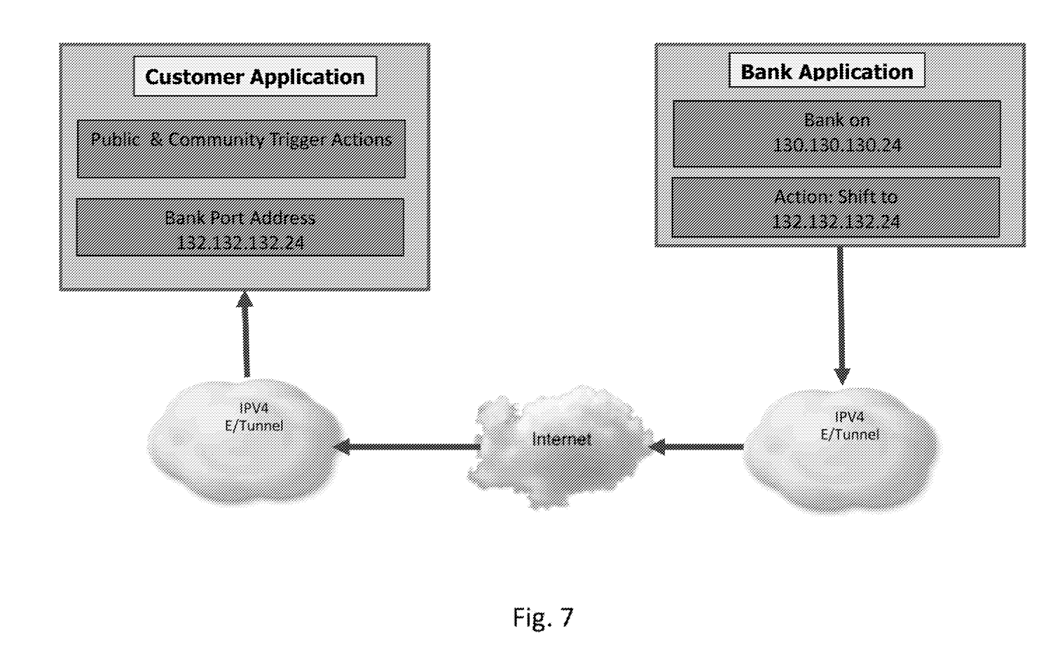

A symmetrical process is initiated and executed by the bank for the customers to learn the alternative web port. The bank's progressive actions shown in FIG. 7 are also reflected in the customers actions. The web port data is included in an encrypted data message (e/bank port message) that would be deciphered and acted upon by the customer.

The market emphasis for information security is to protect the data by an authentication method and ensure that the data is protected in transit. Data is collectively protected, but not individually protected. Data can be considered an object and security associated with that object may be persistent. The advent of the Cloud where data is interspersed in a storage medium adds a dimension to protecting data. Security is not only an access issue, but a distributed access issue within a mix of the Internet packet environment and a data usage environment. A broader view emerges that security can travel with the data and be stored with the data. Security can be enhanced with broader roles for encryption. However, the attacker now still has many potential facets in which a denial of service can be created. The scope of defining access is shifting.

Bringing additional security to the forefront can be a challenge in that legacy and latency exist. The existing Internet and its end points consist of a mix of security devices that must be considered—a legacy picture. Within the infrastructure that network and information security exists includes an acceptable level of latency or a measure of time delay experience in a system.

An existing network packet protocol can be secured independently of an existing data protocol; however, a bridge through triggers can be created at identified points within the overall end-to-end system architecture to reinforce a resultant network access and a data access. A trigger can authenticate and validate a user and his/her network router to an Internet Service Provider while another trigger can recognize and authorize a valid encrypted document or encrypted dataset that has been encapsulated at a Network protocol mode.

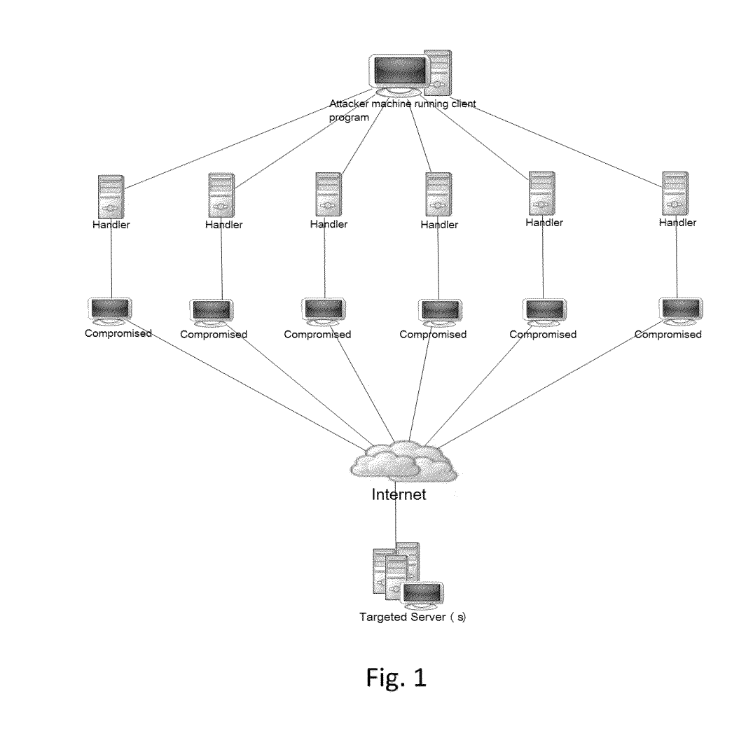

To effect the implementation of a Triggering action, it is necessary to begin with an examination of a sample market environment. FIG. 1 illustrates an edge-to-edge banking security architecture for which Triggering is included.

The left edge of FIG. 1 illustration includes a notation for the bank customer application, which includes the functions for Triggering as well as other optional banking items. The illustration shows that there is a linkage with the customer router, which is a customer linkage to a Network communications protocol identified as Internet Public Trigger. There is a distinction between the security that is available at the Banking Community Trigger level, and the security that is available at the Internet Public Trigger level. The IPSEC Tunnel, or another secure encryption tunnel, is associated with the Banking Community Trigger. The combined security of both levels is affected by Trigger processes and the collective result of the Triggers is used by a third Trigger to perform a countermeasure Web-Port shift Trigger process. The right-edge of the illustration shows a Bank Server, which would be used for exchanging messages with the bank customer.

Reference is made to the banking industry as an example only, for convenience of explanation. The trigger actions and other aspects of the invention can apply and are contemplated for application to other entities, such as those found in the commercial, defense, or intelligence industries.

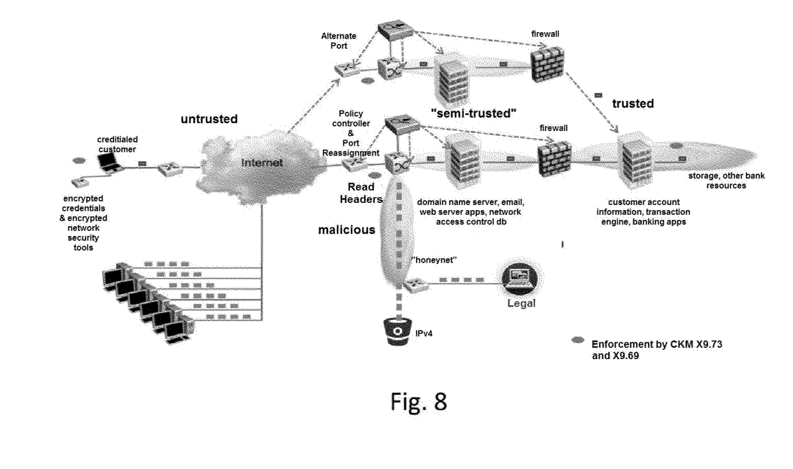

FIG. 8 illustrates components in the edge-to-edge system architecture that can be found for security protection in a banking example.

There are three security environments, namely, those identified as Un-Trusted, Semi-Trusted, and Trusted, and components are included within these security environments. The Un-Trusted environment includes the customer application in the state before Triggering is introduced, and the outside Malware or Denial of Service sources within the Internet. The Semi-Trusted environment exists where security actions take place and differentiation of malicious data is separated from data by one or more Triggers. The Trusted environment exists within an established security boundary illustrated with Firewalls and with a security boundary extension for stored encrypted data or an encrypted document.

FIG. 2 identifies the Network protocol location for two Trigger actions associated with a Bank Community Trigger and an Internet Public Trigger. Both Trigger actions are contained in an IPv4 network packet protocol or an IPv6 network packet protocol. From the perspective of the network packet protocol, the Internet Public Trigger could also be called an ISP Trigger, and the Community trigger may be called Edge Router trigger. A third trigger exists that utilizes the two network triggers for identity and data integrity.

It is not important at this point to include specifics associated with a network protocol but instead to note that the Triggers exist in the IP protocol stack or another protocol of the stack for further actions within the Internet environment.

FIG. 3 focuses on the Internet Network components and two of the three Triggers. The illustration is of an IPSEC and TRIGGER protocol stack.

The two TRIGGER actions identified in FIG. 3 are associated with a Community Trigger (the illustration includes a reference to a specific Banking Community Trigger) and an Internet Public Trigger. Both Trigger actions are contained in an IPv4 network packet protocol or an IPv6 network packet protocol From the perspective of the network pack protocol, the Internet Public Trigger can be also called an ISP Trigger, and the Community trigger may be called Edge Router Trigger.

The Bank Customer Application of FIG. 4 is a product of the bank and is used to communicate with the bank. FIG. 4 includes block diagrams of two sections of the application:
1) The application section includes the components used to establish and utilize the three Triggering actions, as well as access to the application and banking-specific items.
2) The application output section includes the Triggering action components as part of an IP Header input and an IP Data Payload. Components include means for accessing an object-oriented key manager, means for selecting an object to encrypt, means for selecting a label or a name for the object, means for selecting an encryption algorithm, means for encrypting the object, means for labeling or naming the encrypted object, means for reading the object label or name, means for determining access authorization based on the label or name, and means for accessing the object if access authorization is granted.

The Internet Public Trigger exists to establish an authentication and validation schema among the network user, the user's network router, and a first Internet Service Provider (ISP). The capability is provided through a network user application. A security level policy is established for the user application, which will determine a security level for the Internet Public Trigger.

The Internet Public Trigger consists of two elements known to the customer application, to the application owner's edge router, and to the ISP. A prearranged known answer is created for the Public Trigger by a mathematical-cryptographic combination of two numbers:
a) Number One: an exemplary identifier such as: Legal Entity Identifier (LEI—20 Character/Number) or an equivalent identifier established by industry.
b) Number Two: A Network user router IP address that is established with the First ISP (as an example for IPv4, the I address is 32 bits, ex: 172.16.254.1).

A mathematical computation is executed with the two numbers. The resultant computed number is used for the Triggering action. The validation is done at the ISP router, either verifying the computed number, or decrypting the number to determine the prearranged component numbers. The option is present if a latency issue surfaces at the ISP routing.

The Community Trigger: The Community Trigger exists to protect a user's or a bank's data message for transmission and subsequent storage while leveraging an existing packet protocol encryption tunnel or another secure protocol encryption tunnel. The triggering action is done through a network router's action from the initial encryption tunnel key and subsequent encryption header of the user's or bank's document or data message. The Tunnel key established by an object-oriented key manager is accessed, and an object to encrypt is selected. A label or a name for the object and an encryption algorithm are also selected, and the object is encrypted according to the encryption algorithm. The encrypted object, which can be a cryptographic keying establishment, is labeled or named. To access the object, the object label or name is read, access authorization is determined based on the object label or name, and the object is decrypted so that access authorization is granted. The label or name can be, for example, a plurality of labels or names.

The action of validating the encryption tunnel encryption key and validating the data payload encryption header results in a triggering action to further, either store the encrypted message contained in the data payload, or decrypt the encrypted message. The FIG. 6 illustration includes the components of the action within a user application and a bank application as well as the routers for both entities. The Edge router is included in a corporate and institutional back office information processing infrastructure.

A packet protocol encryption tunnel, or another secure protocol encryption tunnel, which is disposed between the user application and the bank edge router, is transparent. As illustrated in FIG. 6, a document or data message that is communicated within the packet protocol encryption tunnel is included in the Data Payload for both entities. The encrypted document or encrypted data message example is of a Constructed Key Management (CKM) framework-encrypted document or encrypted data message.

The encrypted document can be derived from the action of a system configured to provide multiple level multimedia security in a data network. The system includes digital logic means, which in turn includes a system memory means, an encryption algorithm module, an object labelling subsystem, a decryption algorithm module, and an object label identification subsystem. The system memory means is configured to store data. The encryption algorithm module includes logic for converting unencrypted objects into encrypted objects and is electronically connected to the system memory means to enable access to data stored in the first system memory. The object labelling subsystem includes logic means for limiting object access, subject to label conditions, and is electronically connected to the system memory means to enable access to data stored in the system memory means. The object labelling subsystem is also electronically connected to the encryption algorithm module to accept inputs from the encryption algorithm module. The decryption algorithm module includes logic configured to convert encrypted objects into unencrypted objects and is electronically connected to the system memory means to enable access to data stored in the system memory means. The object label identification subsystem includes logic configured to limit object access, subject to label conditions. The object label identification subsystem is electronically connected to the system memory means to enable access to data stored in the system memory means. The object label identification subsystem is also electronically connected to the decryption algorithm module to accept inputs from the decryption algorithm module. The encryption algorithm module works in conjunction with the object labelling subsystem to create an encrypted object such that the object label identification subsystem limits access to an encrypted object.

The creation and management of the Encryption and Decryption Keys for the packet IP tunnel or another cryptographically secure communication path, and the encryption method and process that would establish the secure communications path, may use the Split Key Combiner of CKM as identified and described in the ANSI x9.69 standard.

Security Integrity with Technologies for the Network and Information Continuity: The Internet Public Trigger strengthens identity to the network while the Bank Community Trigger includes a layered security format. Both Triggering processes rely on techniques and frameworks found in encryption. The result of this combination is to counter malware and limit Denial of Services.

Web Port Shift Trigger: The actions of the Public and Community Triggers establish a measured level of security integrity for a further bank or institutional action which specifically focuses on a countermeasure for a Distributed Denial of Service (DDoS).

The bank would like to maintain active correspondence with its customers, but the act of a DDoS attack minimizes or eliminates any continuity. The issue centers with customer access to a bank's website. The DDoS attacker can know sufficient specifics of the website to counter defenses. A technique that exists for the bank to counter such an attack has the bank move to another port. But, maintaining synch with customer in such a bank move has not been effective.

The intent of the Port Shift trigger is to maintain continuity with the bank customer. Others who have yet to become a customer and attempt to contact the bank during a DDos attack will not have access to the countermeasure process.

A bank-to-Internet ISP relationship can exist. Further, the bank can have a dynamic web port address assignment with the ISP that includes a set of web port addresses available for selection.

A DDoS attack is recognized, resulting in triggering actions. The bank decides to shift its current web port to an alternative web port. Actions associated with the Public and Community triggers are executed, followed by an encrypted data message to the bank's customer base stating that a new web port is available and citing the web port information.

The bank's action to shift the web port and synchronize that action with their customer base becomes the triggering action for the Web Port Trigger.

The bank initiates and executes a symmetrical process for the customer to learn the alternative web port. The progressive actions performed by the bank as shown in FIG. 7 are also reflected in the customer's actions. The web port data is included in an encrypted data message (e/bank port message) that is deciphered and acted on by the customer.

AS a countermeasure against Malware, Denial of Service, and Distributed Denial of Service, the Triggering actions: a) support sender address validation through a Network ISP validation; b) support data tagging and label integration; c) can minimize spoofing; d) can complement existing security architectures and frameworks; and e) can complement security for the user in an end-to-end protection schema.

As a basic services management action, the Triggering actions can: a) deny service to non-members of the countermeasure; b) enable Quality of Service (QoS) decisions for selected users; c) complement data routing to correct Network entities; and d) bridge Network IP packet protocol to secure data protocol.

Particular exemplary embodiments of the present invention have been described in detail. These exemplary embodiments are illustrative of the inventive concept recited in the appended claims, and are not limiting of the scope or spirit of the present invention as contemplated by the inventors.

What is claimed is:

1. A process of triggering an Internet packet protocol against malware, comprising providing protocol trigger mechanisms configured to affect network access and data object access against malware, denial of service attacks, and distributed denial of service attacks.

2. The process of claim 1, further comprising providing a protocol trigger that can authenticate and validate a user and their network router to an Internet service provider.

3. The process of claim 1, further comprising providing a protocol trigger that can be used to recognize and authorize a valid encrypted document or encrypted dataset that has been encapsulated at a network protocol mode.

4. The process of claim 1, further comprising providing a protocol trigger that can be used to establish a bridge between a network protocol and data object protocol.

5. The process of claim 1, further comprising validating an Internet public trigger by a mathematical computation of two identity numbers from a security source and the Internet protocol (IP) address.

6. The process of claim 1, further comprising using a trigger to synchronize an institution's actions and a user for customer regarding a web port shift.

7. The process of claim 1, further comprising using the result of the combination of trigger actions to stop a denial of service attack by more efficiently processing the request for connection.

8. The process of claim 7, wherein the combination of trigger actions results in an increased assurance of an exchange of data between parties, including authentication of the included parties, allocation of connection points (port assignment) between parties, and authorization provided in order to access the requested data or information.

9. The process of claim 1, further comprising using multiple triggers within the IPSEC stack or another security protocol in the stack to provide more control and decision points to the network provider, thereby increasing the ability of the provider to make a more efficient and robust connection and more stable information-sharing environment.

10. The process of claim 1, further comprising using one or more triggers, placed within the IPSEC stack or another security protocol in the stack to increase the assurance of identity, confidentiality, availability between the user and a service provider.

11. The process of claim 1, wherein the service provider is one or more of a store, a bank, a government agency, a military agency, or an intelligence agency.

12. A Multi-Level security system established with a cryptographically secure network channel, or another equivalent encrypted channel, and a second object of an encrypted document or data message that uses the secure network channel.

13. The system of claim 12, wherein the another equivalent encrypted channel is a Virtual Private Network tunnel (VPN) including MPPE/PPTP/CIPE/Open VPN, Secure Socket Layer (SSL), or IPSec tunnel.
